(19) United States
(12) Patent Application Publication
(10) Pub. No.: US 2026/0171648 A1
(43) Pub. Date: Jun. 18, 2026

(54) TRANSPARENT ANTENNA APPARATUS FOR VEHICLE

(71) Applicants: Hyundai Motor Company, Seoul (KR); Kia Corporation, Seoul (KR); LG Electronics Inc., Seoul (KR)

(72) Inventors: Oh Yun Kwon, Hwaseong-si (KR); Ui Sheon Kim, Gunpo-si (KR); So Yeon Lee, Seoul (KR); Dong Jin Kim, Seoul (KR); Won Jeong Jeong, Seoul (KR); Byung Woon Jung, Seoul (KR); Kang Jae Jung, Seoul (KR)

(21) Appl. No.: 19/249,767

(22) Filed: Jun. 25, 2025

(30) Foreign Application Priority Data
Dec. 18, 2024 (KR) 10-2024-0190027

(51) Int. Cl. H01Q 1/12

(52) U.S. Cl. CPC H01Q 1/1271

(57) ABSTRACT

In an embodiment a vehicle includes an integration module disposed at any position in the vehicle, the integration module comprising a low noise amplifier module and an antenna module, a metal frame arranged along a part of an edge of a rear glass of the vehicle, a plurality of transparent antennas arranged in the rear glass of the vehicle, a circuit board connected to a power feed part of each of the plurality of antennas from the integration module; and a cable line configured to connect a feeding part of the integration module and the circuit board to each other.

### CROSS-REFERENCE TO RELATED APPLICATIONS

This application claims the benefit of and priority to Korean Patent Application No. 10-2024-0190027, filed on Dec. 18, 2024, the entire disclosure(s) of which is hereby incorporated herein by reference in its entirety.

### TECHNICAL FIELD

The present disclosure relates to a transparent antenna apparatus for a vehicle

### BACKGROUND

The content described hereinbelow merely provides background information on the present disclosure and does not constitute the prior art.

As services provided through a vehicle diversify, various types of antennas are installed in a vehicle. There is a roof antenna which is usually mounted on a roof of the vehicle. The roof antenna is often made in a shape similar to a shark's fin, so it is also called a shark fin antenna.

FIG. 1 is a diagram showing a conventional antenna mounted on a vehicle.

Referring to FIG. 1, in a conventional case, the vehicle may include a roof antenna 100.

The vehicle may further include a glass antenna 130 integrated with a heating element. The glass antenna 130 may be implemented in an area excluding an empty space 120 on the top of a glass 110 so as to operate a High Mount Stop Lamp (HMSL) and a built-in camera.

The glass antenna 130 is integrated with the heating element of the vehicle's glass 110 and is not easily recognizable as an antenna. Hence, the glass antenna 130 does not impair the appearance, thereby improving the overall design completeness of the vehicle.

On the other hand, the roof antenna 100 is an element protruding from the exterior of the vehicle, which disrupts the sense of unity in the vehicle design and is often requested for removal by users for aesthetic reasons. Further, an external antenna is problematic in that air resistance increases when the vehicle is driving, so the fuel efficiency of the vehicle is lowered and driving performance is deteriorated.

Recently, there is a trend to reduce the size of the roof antenna 100 or to remove the roof antenna 100. The reason is because the design of the vehicle's exterior can be improved and air resistance can also be reduced when the size of the roof antenna 100 protruding from the outside of the vehicle is reduced or the roof antenna 100 is removed. However, if the size of the roof antenna 100 is reduced or the roof antenna 100 is removed, there is a concern that a frequency band that the vehicle may receive may be reduced or a communication function may be degraded. For instance, if the roof antenna 100 is removed, another antenna will be needed to replace the roof antenna 100. For example, when the size of the roof antenna 100 is reduced, it is difficult to appropriately arrange a plurality of radiators in an internal space of the reduced roof antenna 100, and interference between the radiators occurs due to narrow spacing between the radiators, thereby causing deterioration in antenna performance.

In order to reduce the size of the roof antenna 100 or to eliminate the roof antenna 100, an antenna that can perform all or some of the functions of the roof antenna 100 is required.

### SUMMARY

Embodiments provides a plurality of transparent antennas arranged in an area of a rear glass of a vehicle.

Embodiments provides a transparent antenna that can perform all or part of the functions of a roof antenna or assist the functions of the roof antenna.

Embodiments are not limited to the above-mentioned embodiments, and other embodiments, which are not mentioned will be clearly understood by those skilled in the art from the following description.

According to an embodiment, it is possible to provide a plurality of transparent antennas arranged in an area of a rear glass of a vehicle.

According to an embodiment, it is possible to provide a transparent antenna that can perform all or part of the functions of a roof antenna or assist the functions of the roof antenna.

### BRIEF DESCRIPTION OF THE DRAWINGS

FIG. 1 is a diagram showing a conventional antenna structure for a vehicle;

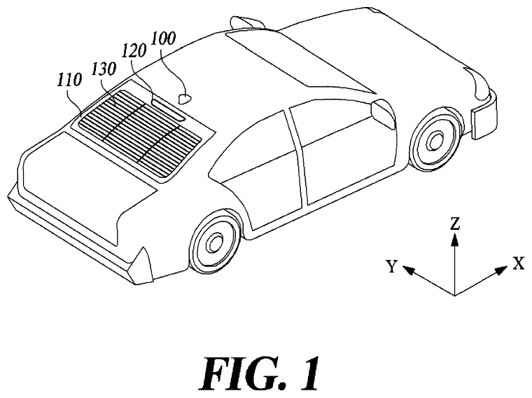

FIG. 2 is a diagram showing a transparent antenna apparatus for a vehicle according to an embodiment of the present disclosure;

FIG. 3 is a rear view showing the transparent antenna apparatus for the vehicle according to an embodiment of the present disclosure, when seen from below;

FIG. 4 is a graph showing a reflection coefficient based on a frequency according to an embodiment of the present disclosure;

FIG. 5 is a graph showing an insertion loss based on a frequency according to an embodiment of the present disclosure;

FIG. 6 is a graph showing the L5 band of an antenna according to the present disclosure;

FIG. 7 is a graph showing the L1 band of the antenna according to the present disclosure; and

FIG. 8 is a diagram showing the distribution and flow direction of an electric field based on a distance between a GNSS antenna and a vehicle body according to the present disclosure.

### DETAILED DESCRIPTION OF ILLUSTRATIVE EMBODIMENTS

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’or ‘comprises’a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

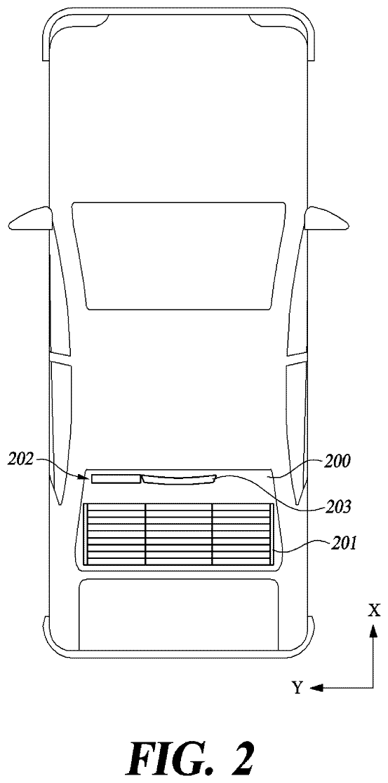

FIG. 2 is a diagram showing a transparent antenna for a vehicle according to an embodiment of the present disclosure.

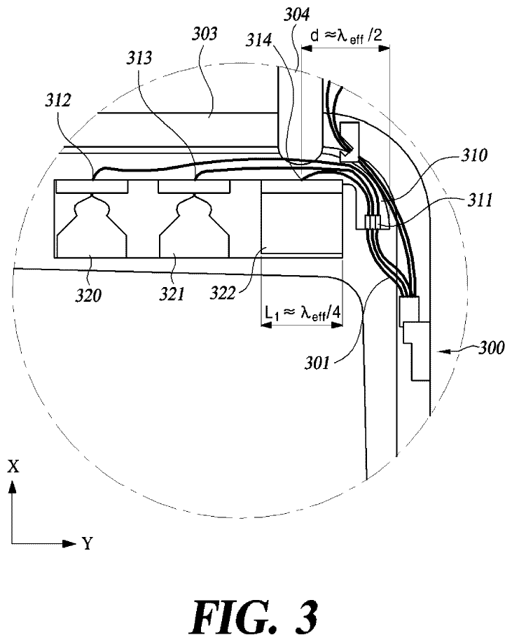

FIG. 3 is a rear view showing the transparent antenna for the vehicle according to an embodiment of the present disclosure, when seen from below.

Referring to FIGS. 2 and 3, a transparent antenna apparatus for a vehicle according to the present disclosure includes some or all of an integration module 300, a flexible circuit board 310, a plurality of antennas 202, and a cable line 301.

The integration module 300 according to the present disclosure may be disposed at any position in the vehicle. For example, the integration module 300 is disposed at either of a left C-pillar 303 or a right C-pillar 303 of the vehicle. Specifically, the integration module 300 may be disposed adjacent to the plurality of antennas 202 to be described later, either on the left C-pillar 303 or the right C-pillar 303. The C-pillar 303 of the vehicle refers to a third frame positioned from the front to the rear among frames placed along the side of the vehicle. The C-pillar 303 is a support structure between front and rear windows, connecting the roof and body of the vehicle and increasing the rigidity of the vehicle.

For example, the plurality of antennas 202 according to the present disclosure is disposed in a position where they do not contact a heating element 201 formed on the rear glass 200 of the vehicle.

When the integration module 300 according to the present disclosure is disposed in the C-pillar 303, a physical distance between the plurality of antennas 202 and a low noise amplifier (LNA) may be minimized. This may be an important factor in receiving a high-frequency signal. The shorter a path between the plurality of antennas 202 and the LNA, the less the RF path loss and the better the reception performance. In particular, since a high frequency signal in the GHz band handled by a GNSS antenna 322 and CCS antennas 320 and 321 according to the present disclosure has large path loss, reducing signal attenuation can maintain the reception quality of the antenna.

Further, the C-pillar 303 is easily electrically grounded with the vehicle body, so that the LNA and a metal frame 304 may form a common ground. The common ground serves to suppress electromagnetic interference (EMI) and improve the signal quality of the antenna. For example, if the integration module 300 is disposed in a position other than the C-pillar 303, it is difficult to achieve stable ground with the vehicle body, which increases the possibility of noise being introduced into the received signal and leads to a deterioration in the performance of the antenna.

Further, because the upper portion of the rear glass 200 of the vehicle may have limited free space, it may be difficult to install the integration module 300 therein. However, the C-pillar 303 may have free space, allowing the integration module 300 to be stably disposed. Thus, when a worker assembles the integration module 300, assembly can be made easier and efficiency in the manufacturing process can be increased.

A transparent antenna apparatus for a vehicle according to another embodiment of the present disclosure exhibits a structure in which the placement position of the integration module 300 may be flexibly applied depending on the type of vehicle.

The vehicle according to an embodiment including the A-pillar or the C-pillar has the integration module 300 disposed in the C-pillar 303, but a wagon-style vehicle and a minivan vehicle include the A-pillar or the C-pillar and further include a structure extending to a D-pillar formed at the rear of the C-pillar. Therefore, when the integration module 300 is applied to a wagon or minivan vehicle, it may be preferable that the integration module 300 be placed on the D-pillar adjacent to the rear glass 200.

The integration module 300 according to the present disclosure may be an integrated module structure that includes both a CCS antenna (Cellular Communication System antenna, not shown) and a GNSS antenna (Global Navigation Satellite System antenna, not shown). Here, the horizontal and vertical lengths of the CCS antenna disposed inside the integration module 300 may be configured as 2 cm and 2 cm. The CCS antenna and GNSS antenna placed inside the integration module 300 may perform the same functions as a first CCS antenna 320, a second CCS antenna 321, and a GNSS antenna 322 described in the present disclosure.

The GNSS antenna 322 receives a satellite signal to provide accurate position information. For example, amplification of the received signal is required. Therefore, the GNSS antenna 322 is configured to amplify the received signal by including a low noise amplifier (LNA). Here, the low-noise amplifier may improve the performance of the GNSS system by maintaining the purity and intensity of the signal through low-noise amplification of the GNSS signal.

Further, the integration module 300 according to the present disclosure manufactures antennas as an integrated structure and connects them as one, taking into consideration the appearance quality, cost, and assembling ability. This simplifies the appearance of the module, improves the sense of unity in the vehicle design, and avoids installation space issues that may arise when designing individual antennas. The integrated integration module 300 can reduce the number of components, thereby reducing the manufacturing cost of the transparent antenna apparatus for the vehicle and improving the efficiency of the assembly process.

The CCS antennas 320 and 321 according to the present disclosure refer to antennas that receive and transmit mobile communication network signals such as 4G LTE and 5G NR. The CCS antennas 320 and 321 perform various communication functions within the vehicle, and provide vehicle-to-vehicle (V2V) communication, vehicle-to-infrastructure (V2I) communication, and connectivity with cloud-based services. The CCS antennas 320 and 321 can support simple voice calls and data transmission as well as high-speed data communication required for vehicle telematics systems and autonomous driving.

The CCS antennas 320 and 321 according to the present disclosure operate primarily in a wide frequency range including a Sub-6 GHz band (3.3 GHz to 4.2 GHz) and a mmWave band (24 GHz to 40 GHz). The Sub-6 GHz band provides wide coverage and stable connectivity, while the mmWave band has a wide bandwidth and enables high-speed data transmission. For example, in the Sub-6 GHz band, representative frequencies are 3.5 GHz and 4.2 GHz, and the wavelengths in this band are calculated to be approximately 8.57 cm and 7.14 cm, respectively. On the other hand, in the mmWave band, the wavelength is much shorter and is measured to be about 1.15 cm in the 26 GHz band, for example.

The CCS antennas 320 and 321 have multiband characteristics to support various frequencies. Since the antenna size may be reduced in the high-frequency band, it is desirable to design a small antenna that can maintain high efficiency without protruding to the exterior of the vehicle. In particular, in the Sub-6 GHz band, a gap between the antenna and the vehicle body is adjusted to half (ë/2) or ¼ (ë/4 ) of the effective wavelength to minimize the influence of the vehicle's internal structure and metal frame 304.

The GNSS antenna 322 according to the present disclosure is an antenna designed to receive a signal from a global satellite navigation system. The GNSS antenna 322 receives position, velocity, and time information transmitted from the satellite and calculates an accurate position.

The GNSS antenna 322 operates in the L band frequency band. The L band is a frequency band in which the GNSS satellite signal is transmitted, and is typically located between 1.1 and 1.6 GHz. Among the L bands, the representative ones are the L1 band (approximately 1.57542 GHz) and the L5 band (approximately 1.17645 GHz). In addition, GLONASS transmits signals at 1.602 GHz, and Galileo transmits signals at 1.17645 GHz and 1.27845 GHz. In this frequency band, the GNSS antenna 322 is designed to receive a signal from each satellite system, and stably receives the satellite signal using circular polarization due to the characteristics of the signal.

The effective wavelength of the GNSS antenna 322 is determined at the lowest frequency that the GNSS antenna 322 receives. For example, the effective wavelength in the L5 band (1.17645 GHz) of GPS is calculated to be approximately 25.48 cm. The effective wavelength is related to the period of the wave. The lower the frequency, the longer the wavelength. Since this length affects the size and arrangement of the GNSS antenna 322, the GNSS antenna 322 according to the present disclosure has a horizontal length (L1) equal to ¼ of the effective wavelength length (λeff) of the lowest frequency domain.

The flexible circuit board 310 according to the present disclosure has a predetermined size to accommodate all power feed parts of the plurality of antennas 202 spaced apart from each other within a corner area of the rear glass 200.

The flexible circuit board 310 is formed in a shape that does not overlap a protrusion of the metal frame 304. Here, the protrusion of the metal frame 304 is partially protruded and a hole is formed for assembly with other units constituting the vehicle using screws or bolts. However, the protrusion of the metal frame 304 may also be formed to perform the role of alleviating vibration and shock, or guiding each component to be placed in an accurate position during the assembly process.

The plurality of antennas 202 according to the present disclosure include at least two CCS antennas 320 and 321, and the GNSS antenna 322.

The two or more CCS antennas 320 and 321 according to the present disclosure may include a first CCS antenna 320 and a second CCS antenna 321.

The first CCS antenna 320, the second CCS antenna 321, and the GNSS antenna 322 according to the present disclosure include power feed parts 312, 313, and 314 connected to the flexible circuit board 310, respectively.

The first CCS antenna 320 includes the first power feed part 312. The second CCS antenna 321 includes the second power feed part 313. The GNSS antenna 322 includes the third power feed part 314.

Each of the first power feed part 312, the second power feed part 313, and the third power feed part 314 receives an electrical signal transmitted from outside or transmits a transmission signal. Each of the first power feed part 312, the second power feed part 313, and the third power feed part 314 is configured to control the electrical signal flow of at least two CCS antennas 320 and 321 and the GNSS antenna 322, to minimize signal loss, and to maintain impedance matching between each antenna and an external circuit. Here, the impedance matching refers to matching the impedance of the flexible circuit board 310 connected to each antenna.

The plurality of antennas 202 according to the present disclosure may be attached and disposed on the rear glass 200. For example, the plurality of antennas 202 are disposed on the upper left corner area or the upper right corner area of the rear glass 200.

The GNSS antenna 322 is disposed closest to the C-pillar 303 that functions as a ground. Further, at least two CCS antennas 320 and 321 may be placed in a direction away from the C-pillar 303 with respect to the GNSS antenna 322.

The GNSS antenna 322 may be disposed so that the power feed part is located at a distance of half an effective wavelength from an area of the metal frame 304 adjacent to the C-pillar 303.

When the GNSS antenna 322 according to the present disclosure is placed in either the upper left corner area or the upper right corner area of the rear glass 200, it is placed adjacent to the body ground, and thus the antenna circular polarization characteristics can be improved. Further, it may be spaced apart from a HMSL area 203 to reduce the inflow of RF noise. Furthermore, it may be placed adjacent to the LNA module for GNSS placed in the C-pillar 303, thereby minimizing the RF loss. On the other hand, when the CCS antennas 320 and 321 are placed on the corner, performance may be deteriorated due to the influence of the body ground. Therefore, in the plurality of antennas 202 according to the present disclosure, the GNSS antenna 322 may be placed closest to the C-pillar 303 functioning as the ground and at least two CCS antennas 320 and 321 may be placed in a direction away from the C-pillar 303 with respect to the GNSS antenna 322.

The present disclosure is connected to the power feed part of each of the plurality of antennas 202 using the flexible circuit board 310.

Considering the loss of the flexible circuit board 310, the cable line 301 is connected between the flexible circuit board 310 and the integration module 300.

The cable line 301 according to the present disclosure may be partially fixed to a fixed portion formed by being attached to the inner surface of the rear glass 200.

The cable line 301 is connected to a feeding part 311 formed on the flexible circuit board 310. The cable line 301 is configured to prevent the line loss of the flexible circuit board 310. Further, the cable line 301 may be connected between the flexible circuit board 310 attached to the back surface of the rear glass 200 and the integration module 300 placed on the C-pillar 303.

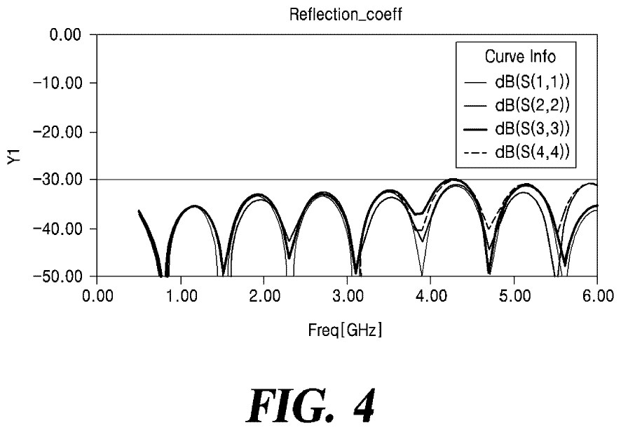

FIG. 4 is a graph showing a reflection coefficient based on a frequency according to an embodiment of the present disclosure.

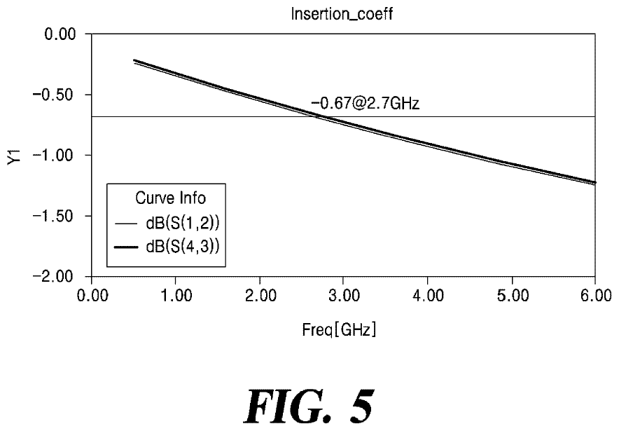

FIG. 5 is a graph showing an insertion loss based on a frequency according to an embodiment of the present disclosure.

Referring to FIGS. 4 and 5, the plurality of antennas 202 according to the present disclosure are attached to the rear glass 200.

In the present disclosure, reflection coefficient and insertion loss simulations may be performed using the rear glass 200 having the thickness of 3.5 mm, for example. Within the structure of the rear glass 200, two channels with a spacing of 11 mm are provided, the spacing between the channels is set to 3 mm, and the length of a transmission line is designed to be 100 mm.

As a result of analyzing the transmission characteristics of the present disclosure through the reflection coefficient and insertion loss simulation, it can be seen that the loss of about 0.7 dB per 100 mm occurs in the transmission line. Further, an insertion loss graph shows the insertion loss of about −0.67 dB in the 2.7 GHz frequency band. This means that the plurality of antennas 202 according to the present disclosure are configured to enable stable signal transmission in the corresponding frequency band.

The reflection coefficient graph maintains the value of −30 dB or less within the band of 0 to 6 GHz, which shows that the reflection of the plurality of antennas 202 applied to the rear glass 200 is minimized, resulting in efficient signal transmission.

Subsequently, the specific insertion loss graph and reflection coefficient graph will be described later.

The insertion loss graph according to the present disclosure shows the characteristics of signal insertion loss according to frequency. The insertion loss is expressed as S-parameter values S12 and S34. This represents a degree to which an input signal is lost while passing through a glass internal channel.

A curve shown in the insertion loss graph shows the loss of −0.67 dB in the 2.7GHz frequency band. This means that the loss during signal transmission is very low, less than 1 dB, enabling efficient signal transmission. Further, this insertion loss graph confirms that the line loss is at the level of 0.7 dB per 100 mm, indicating that low loss is maintained even at a length of 100 mm.

Although the insertion loss graph shows a tendency for the loss to gradually increase as the frequency increases, the structure of the transparent antenna apparatus for the vehicle according to the present disclosure still maintains low loss even at a high frequency, thereby enabling stable communication performance in various frequency bands.

The reflection coefficient graph according to the present disclosure shows the characteristics of reflection loss according to frequency. The reflection coefficient is expressed as the S-parameter values S11, S22, S33, and S44, and each S-parameter means the reflection characteristic at a corresponding port.

All of dB(S1,1), dB(S2,2), dB(S3,3), and dB(S4,4) curves shown in the reflection coefficient graph maintain values of −20 dB or less. The reflection loss of −20 dB or less means that very little signal is reflected within the frequency band, meaning that most of the input signal passes through to the next stage without reflection.

Peak values at different frequencies in the reflection coefficient graph indicate that reflections may occur at certain frequencies. However, since this peak is also maintained at −20 dB or less, stable communication performance may be achieved in various frequency bands.

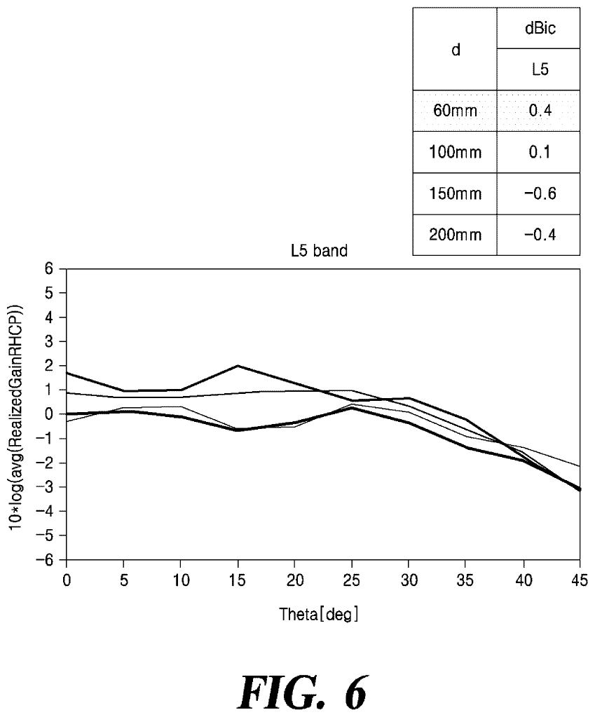

FIG. 6 is a graph showing the L5 band of the antenna according to the present disclosure.

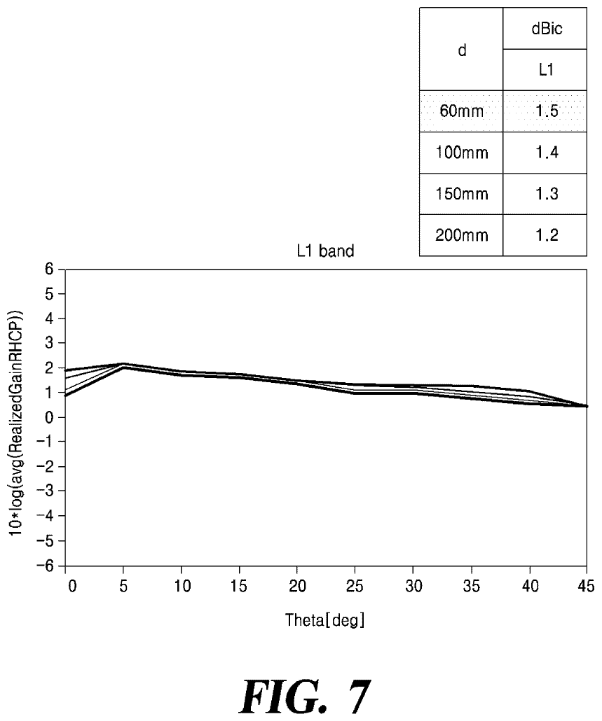

FIG. 7 is a graph showing the L1 band of the antenna according to the present disclosure.

Referring to FIGS. 6 and 7, the L5 band and L1 band graphs of the antenna according to the present disclosure show an extent to which the gain (Realized Gain) in each band changes depending on an incident angle (Theta). The L5 and L1 bands are one of the frequency bands of the GNSS antenna 322 and are important factors in evaluating the performance of the vehicle antenna.

The graphs of the L5 band and the L1 band according to the present disclosure represent information obtained through simulation to confirm the influence between the GNSS antenna 322 and the vehicle body.

Specifically, the RHCP circular polarization gain is calculated and compared while reducing a distance between the third power feed part 314, which is the center of the GNSS antenna 322, and the vehicle body side of the C-pillar 303 from 200 mm to 60 mm. Through the simulation, it can be confirmed that the circular polarization gain improves as the distance between the GNSS antenna 322 and the side of the vehicle body decreases.

The L5 band graph shows high gain in the small incident angle range, and the gain tends to gradually decrease as the angle increases. This means that when a signal in the L5 band is received at various angles, there may be signal loss at some angles, but it is designed to maintain stable signal performance at most angles.

The L1 band graph shows a relatively gradual change in gain with respect to the incident angle, maintaining a stable gain without a significant fluctuation depending on the angle. These characteristics indicate that the L1 band is designed to provide consistent performance at various incident angles, enabling stable GNSS signal reception even while the vehicle is moving.

Further, a table showing d distance and gain dBic discloses the gain according to distance d in the L5 and L1 bands. For example, when the distance is 60 mm, the gain is 0.4 dBic in the L5 band and 1.5 dBic in the L1 band. This means that it can provide stable signal performance when the distance is 60 mm in each band.

The GNSS antenna 322 according to the present disclosure is designed to maintain a stable signal gain according to the incident angle and distance conditions, and is optimized to exhibit efficient performance particularly in the L5 and L1 bands of the GNSS antenna 322.

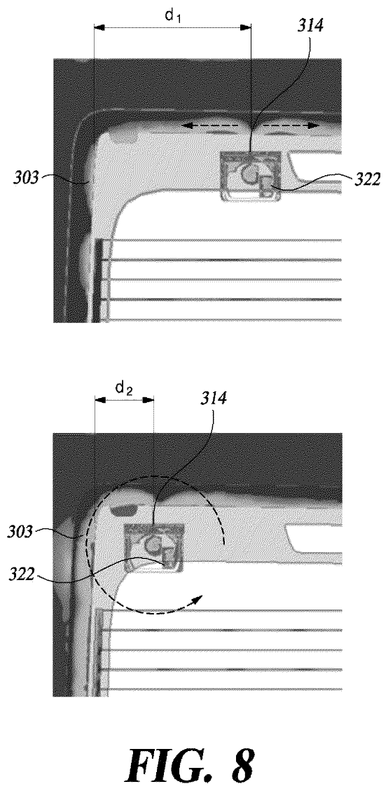

FIG. 8 is a diagram showing the distribution and flow direction of an electric field based on a distance between the GNSS antenna 322 and the vehicle body according to the present disclosure.

Referring to FIG. 8, the distribution and flow direction of the electric field are shown based on the distance between the GNSS antenna 322 and the vehicle body side of the C-pillar 303.

Polarization refers to a phenomenon in which the electric field (E-field) of an electromagnetic wave is aligned in a specific direction. When the GNSS antenna 322 receives a signal, the more the polarization of the signal being received matches the polarization of the antenna, the more efficiently the signal can be received. Since the GNSS signal generally has circular polarization, the GNSS antenna 322 according to the present disclosure is also designed for circular polarization.

Specifically, if the E-field intensity increases, a stronger electric field is formed around the GNSS antenna 322. The electric field formed here can stably align the direction of the electric field around the GNSS antenna 322. In other words, as the intensity of the E-field increases, the electric field is formed more clearly in a specific direction, making it easier for the GNSS antenna 322 to form polarization in that direction. In particular, when the GNSS antenna 322 is close to the vehicle body side of the C-pillar 303, the vehicle body side of the C-pillar 303 reflects and disperses the electric field, thereby causing the E-field to flow in a specific direction. This makes the flow of the electric field for maintaining the circular polarization more distinct, which can facilitate the reception of the circular polarization signal such as the GNSS signal. Therefore, as the distance between the GNSS antenna 322 and the vehicle body side of the C-pillar 303 becomes shorter and the E-field intensity increases, the flow of the electric field is formed stably and strongly. This allows the electric field to be more aligned and concentrated around the GNSS antenna 322, and is advantageous for polarization formation that can effectively receive the GNSS signal.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A vehicle comprising:
an integration module disposed at any position in the vehicle, the integration module comprising a low noise amplifier module and an antenna module;
a metal frame arranged along a part of an edge of a rear glass of the vehicle;
a plurality of transparent antennas arranged in the rear glass of the vehicle;
a circuit board connected to a power feed part of each of the plurality of antennas from the integration module; and
a cable line configured to connect a feeding part of the integration module and the circuit board to each other.

2. The vehicle of claim 1, wherein the integration module is attached to either a C-pillar or a D-pillar of the vehicle, and attached adjacent to the plurality of transparent antennas.

3. The vehicle of claim 1, wherein the cable line is fixed to an inner surface of the rear glass.

4. The vehicle of claim 1, wherein the plurality of transparent antennas comprise at least two Cellular Communication System (CCS) antennas and a Global Navigation Satellite System (GNSS) antenna.

5. The vehicle of claim 4, wherein the GNSS antenna is placed closer to a C-pillar or D-pillar functioning as a ground than the at least two CCS antennas.

6. The vehicle of claim 4, wherein the power feed part of the GNSS antenna is located at a distance of ½ an effective wavelength from the metal frame, and wherein the metal frame is located adjacent to a C-pillar or a D-pillar.

7. The vehicle of claim 1, wherein the circuit board accommodates all power feed parts of the plurality of antennas spaced apart from each other within a corner area of the rear glass, and wherein the circuit board does not overlap with a protrusion of the metal frame.

8. The vehicle of claim 4, wherein the GNSS antenna has a length equal to ¼ of an effective wavelength length of a lowest frequency of its frequency domain.

9. The vehicle of claim 1, wherein the circuit board and the plurality of antennas are either attached to an inner surface of the rear glass or to be inserted within the inner surface of the rear glass.

10. The vehicle of claim 1, wherein the transparent antennas do not contact a heating element arranged in the rear glass of the vehicle.

11. The vehicle of claim 1, wherein at least one antenna of the integration module is configured to perform the same functions as the plurality of transparent antennas arranged at the rear glass.

12. The vehicle of claim 1, wherein the circuit board is a flexible circuit board.

13. An antenna apparatus comprising:
an integration module comprising a low noise amplifier;
a plurality of transparent antennas disposed in a glass, wherein the plurality of transparent antennas comprises at least two Cellular Communication System (CCS) antennas and a Global Navigation Satellite System (GNSS) antenna;
a circuit board connected to power feed parts of each of the plurality of transparent antennas; and
a cable line connecting a feeding part of the circuit board to the integration module.

14. The antenna apparatus of claim 13, further comprising a metal frame arranged at the glass, wherein the metal frame forms a common ground with a pillar, wherein the metal frame is connected to the low noise amplifier, and wherein the GNSS antenna is disposed so that its power feed part is located at a distance of half an effective wavelength from an area of the metal frame that is adjacent to the pillar.

15. The antenna apparatus of claim 13, wherein the circuit board does not overlap with a protrusion of a metal frame.

16. The antenna apparatus of claim 13, wherein the integration module further comprises at least one antenna.

17. The antenna apparatus of claim 13, wherein the cable line is fixed to an inner surface of the glass with a fixing part.

18. The antenna apparatus of claim 13, wherein the circuit board is a flexible circuit board.

19. The antenna apparatus of claim 13, wherein the integration module and the plurality of transparent antennas are configured to operate in a complementary manner so that at least one antenna in the integration module provides signal redundancy for reception reliability.

20. A method comprising:
determining an optimal distance between a Global Navigation Satellite System (GNSS) antenna and a vehicle body side of a C-pillar or a D-pillar, wherein the optimal distance is determined based on circular polarization gain;
positioning the GNSS antenna on a rear glass of the vehicle at the determined optimal distance from the vehicle body side of the C-pillar or the D-pillar, wherein the circular polarization gain improves as the distance between the GNSS antenna and the vehicle body side decreases; and
aligning an electric field flow around the GNSS antenna by utilizing vehicle body as a reflective surface to enhance circular polarization characteristics of the GNSS antenna.
